(19) United States
(12) Patent Application Publication
(10) Pub. No.: US 2010/0299306 A1
(43) Pub. Date: Nov. 25, 2010

(54) STORAGE SYSTEM HAVING FILE CHANGE NOTIFICATION INTERFACE

(75) Inventors: Masakuni AGETSUMA, Yokohama (JP); Atsushi Sutoh, Yokohama (JP); Hitoshi Kamei, Sagamihara (JP); Nobumitsu Takaoka, Sagamihara (JP)

Correspondence Address: FOLEY AND LARDNER LLP;SUITE 500, 3000 K STREET NW, WASHINGTON, DC, 20007, US

(73) Assignee: HITACHI, LTD.

(21) Appl. No.: 12/501,061

(22) Filed: Jul. 10, 2009

(30) Foreign Application Priority Data
May 22, 2009 (JP) 2009-123701

(51) Int. Cl. G06F 17/30

(52) U.S. Cl. 707/609; 718/1; 707/822

(57) ABSTRACT

The present invention provides a file operation notifying program for detecting a file operation of an application in a virtual file server on a server machine, and notifying the file operation to an application on another virtual file server inside the server machine, and to an application external to the server machine based on a notification management table.

### CROSS-REFERENCE TO PRIOR APPLICATION

This application relates to and claims the benefit of priority from Japanese Patent Application number 2009-123701, filed on May 22, 2009 the entire disclosure of which is incorporated herein by reference.

### BACKGROUND

The present invention generally relates to an inter-server file operation notification method, system, device and program.

To consolidate the operation and management of file server machines and reduce management costs, a proposal has been put forth for file server consolidation, which uses a single file server machine to provide a file sharing service that used to be provided by a plurality of file server machines. File server consolidation makes use of a virtual file server to make it possible to provide a file sharing service provided via a plurality of file server machines using a single file server machine. A virtual file server is technology for making it appear like a plurality of file server machines is running virtually on a single file server machine by dividing the hardware resources of a single physical file server machine into a number of partitions and running a file server program on each of the partitioned resources.

Japanese Patent Application Laid-open No. 2004-227127 and Japanese Patent Application Laid-open Publication No. 2003-223346 disclose virtual file server technologies that partition a portion of a file server machine's resources with a single OS running on a server machine to create an execution environment having a plurality of independent file name spaces and file server programs.

Further, generally speaking, methods for notifying an application of a file change in a file system have been proposed to achieve file operation-related linkage among a plurality of applications running on a server machine. For example, there is an interface called a FindFirstChangeNotification for an application to monitor changes to a specific file with a single OS running on a server machine.

### SUMMARY

In the related art, only an application that was able to reference a file was targeted to receive the file change notification. That is, a case in which file change-triggered linkage is achieved among a plurality of applications is premised on the fact that the respective applications are running on the same OS and are able to reference the same file. For this reason, it was not possible for applications (file server programs) on a plurality of virtual file servers running on different OS and having different file name spaces to operate in a linked manner with one another as the result of a specific file change.

Accordingly, an object of the present invention is to provide an infrastructure, which, in a case where an application running on a virtual file server of a server machine performs an operation with respect to a file, detects the file operation and notifies an application running on another virtual file server inside the server machine and an application running on an external server machine, making it possible for applications running on different server machines and different virtual file servers to operate in a linked manner with one another.

The present invention provides a file server having a plurality of virtual file servers coupled to a client machine, a storage device having one or more volumes, and a management machine. The file server manages each of the applications running on the plurality of virtual file servers, the type of file operation performed by the application, and the application that constitutes a notification destination of the file operation from among the applications on the above-mentioned plurality of virtual file servers in association with each other.

Upon detecting a file operation from an application on the virtual file server, a file operation notifying program of the file server specifies the application constituting the notification destination of the file operation from among the plurality of applications on the virtual file server based on the application on the virtual file server that has performed the file operation and the file operation type, and notifies the file operation to the specified application.

According to the present invention, in a case where a file operation is generated by a certain virtual file server application inside a server machine, it is possible to notify the file operation to an application running on another virtual file server inside the server machine and a plurality of external server machine applications, creating opportunities for linked operability among applications.

### BRIEF DESCRIPTION OF THE DRAWINGS

FIG. 1 is a block diagram showing the hardware configuration of an embodiment of the present invention;

FIG. 2 is a block diagram showing the software configuration of the embodiment of the present invention;

FIG. 3 is the software configuration of a file operation notifying program;

FIG. 4 is an example of a notification management table;

FIG. 5 is an example of a group management table;

FIG. 6A is an example of a server management table;

FIG. 6B is an example of a server management table;

FIG. 7 is an example of a table for managing an IP address for communicating with the file operation notifying program;

FIG. 8 is a schematic diagram of a send queue;

FIG. 9A is a flowchart of processing for detecting a file operation;

FIG. 9B is a flowchart of processing for detecting a file operation;

FIG. 10 is a flowchart of processing for receiving a file operation notification;

FIG. 11 is a flowchart of processing for requesting status information;

FIG. 12 is a flowchart of processing for sending a status information reply;

FIG. 13 is a flowchart of processing for sending a file operation notification;

FIG. 14 is an example of a management window via which a system administrator performs a file operation notifying program setting;

FIG. 15 is an example of a management window via which a system administrator performs a group setting for the file operation notifying program; and

FIG. 16 is a schematic diagram showing an overview of the present invention.

### DETAILED DESCRIPTION OF THE EMBODIMENTS

The embodiment of the present invention will be explained below.

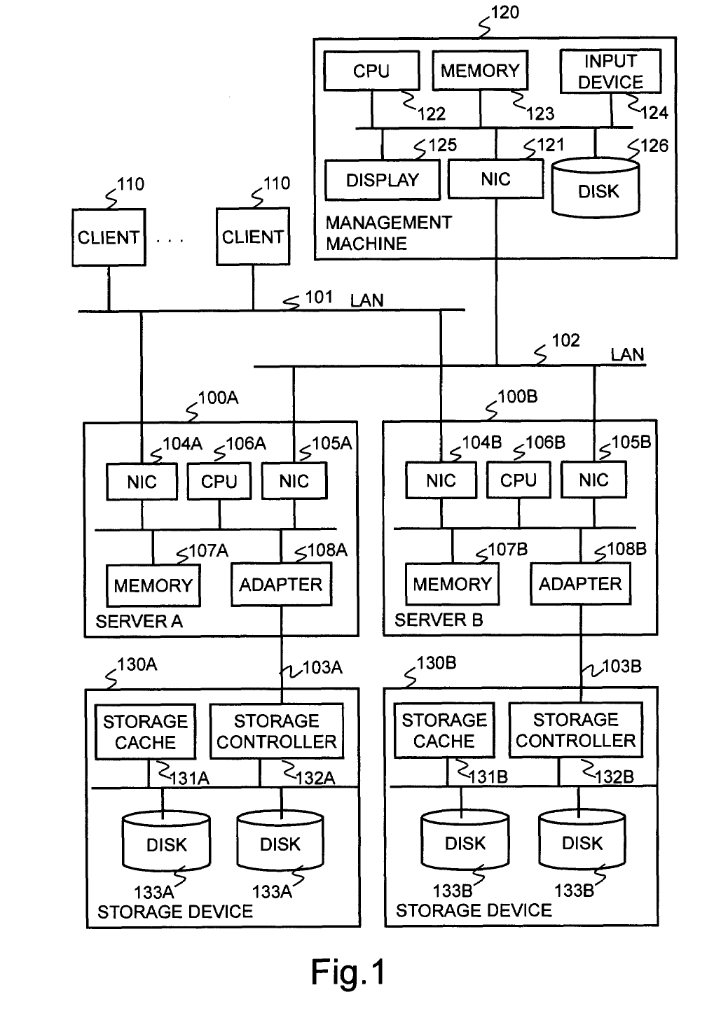

FIG. 1 is a block diagram showing the configuration of an information processing system configured from a server machine 100 (hereinafter abbreviated as server); a management machine 120; one or more client machines 110 (hereinafter abbreviated as client); and a storage device 130.

The server 100 is a machine for providing a client with so-called access, such as a read or write with respect to file data corresponding to a file request from the client, file creation, deletion and attribute referencing, and directory creation, deletion and attribute referencing as a file sharing service. The server 100 is configured from NIC (Network Interface Cards) 104, 105; a CPU (Central Processing Unit) 106; a memory 107; and an adapter 108, and these respective component parts are connected via either an internal bus or an internal network. Furthermore, the NIC 104, CPU 106, memory 107 and adapter 108 are not limited to the number respectively shown in FIG. 1. Further, the number of servers 100 is not limited to the two shown in FIG. 1. Each server 100 may also be configured from a plurality of machines that have a function for linking the respective machines to realize a single virtual file server.

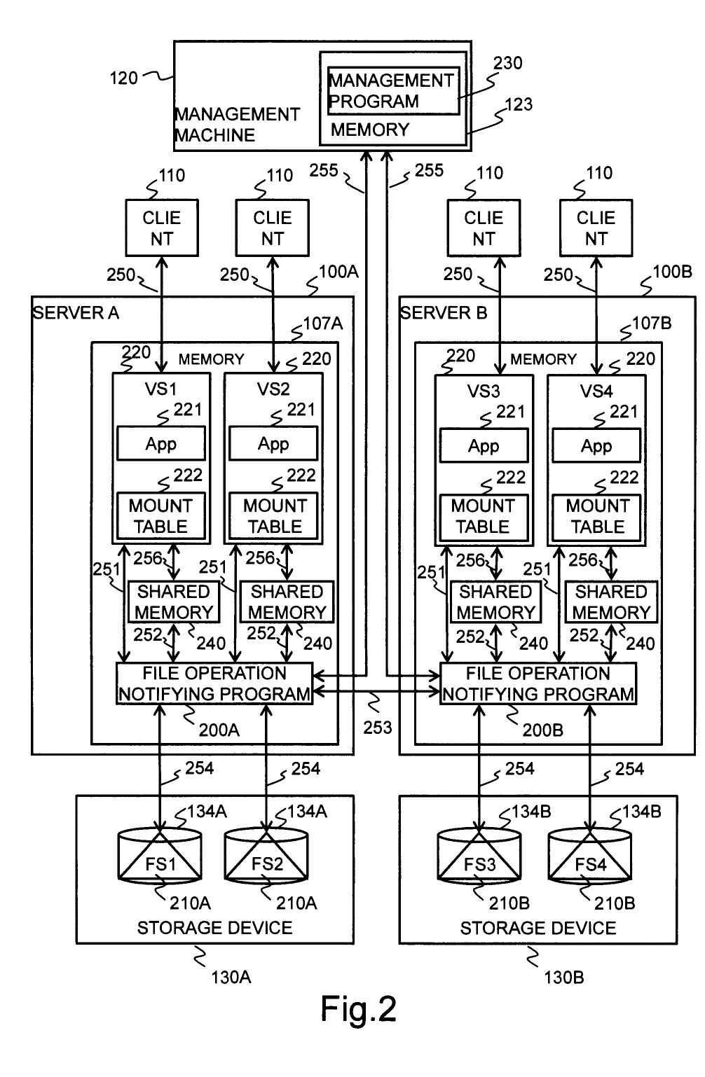

The CPU 106 is a processor for controlling the server 100. The CPU 106 executes a program stored in the memory 107. For example, the CPU 106 executes a program (server program) for providing a file sharing service, and provides a file stored in the storage device 130 to the client 110. FIG. 2 shows the detailed configuration of the programs inside the memory 107.

The memory 107, for example, is a semiconductor memory, and is the primary storage device for storing the programs executed by the CPU 106 and the data and a file cache referenced by the CPU 106. Furthermore, an HDD or other such storage device that is slower than a semiconductor memory may also be incorporated and used as part of the memory 107.

The NIC 104 is used for sending and receiving data for the server 100 to communicate with the client 110. Also, NIC 105 is used for sending and receiving data for the server 100 to communicate with the management machine 120. The server 100, the client 110 and the management machine 120 communicate with one another using a network protocol such as TCP or UDP. Furthermore, the NIC may also be called a network port. For reasons of performance and reliability, it is preferable that the NIC 104 and the NIC 105 be separate hardware components, but the same hardware component may also be used as the NIC 104 and the NIC 105.

The adapter 108 is used for connecting the server 100 and the storage device 130, which is a secondary storage device. The CPU 106 may send a block address-format access request, which represents the read or write of a program or file stored in the storage device 130, and may receive data via the adapter 108. Furthermore, from the standpoint of carrying out communications, the adapter 108 may be the same hardware as the NIC 104 and the NIC 105, but from the standpoints of performance and reliability, it is preferable that the adapter 108 be a different hardware component from the NIC 104 and the NIC 105. Although described in more detail below, in the present invention, the NIC 104 receives a file-format access request from the client 110, and sends the client 110 either data or control information corresponding to the request, but the adapter 108 sends a block address-format access request created by the CPU 106, and may receive block-format data from the storage device 130 or may receive control information.

The client 110 is a machine for accessing the file sharing service provided on the server 100. Although not shown in the drawing, the client 110 is configured from a CPU, a memory and a NIC.

The management machine 120 is for managing the server 100 and a program that is running on the server 100. The management machine 120 is configured from a NIC 121, a CPU 122, a memory 123, an input device 124, a display 125 and a built-in disk device 126, and the respective component parts are connected via either an internal bus or an internal network.

The NIC 121 is used for communicating with the server 100 by way of a LAN 102.

The CPU 122 is a processor for controlling the management machine 120. The CPU 122 executes a program stored in the memory 123. For example, the CPU 122 executes a program (management program) for managing the server 100, and changes the settings of a program that is running on the server 100.

The memory 123, for example, is a semiconductor memory, and is the primary storage device for storing a program executed by the CPU 122 and data that is referenced by the CPU 122. Furthermore, the built-in disk device 126 may also be used as the memory.

The input device 124 is a keyboard or a mouse for giving an instruction to a program running on the management machine 120. The display 125 is an output device for displaying the user interface of a program that is running on the management machine 120. There may also be a plurality of management machines 120. Furthermore, the input device and display may also be operated by a machine other than the management machine 120. In accordance with this, the management machine 120 receives an input to the operating machine 120 as a communication, and, similarly, the management machine 120 sends information to be displayed to the operating machine, and the operating machine, which receives this display information, performs the screen display in accordance with the display information.

The storage device 130 is a secondary storage device for storing a program and file used by the server 100. The storage device 130 is configured from a storage cache 131; a storage controller 132; and a disk device 133, and these respective component parts are connected by either an internal bus or an internal network. The storage cache 131, the storage controller 132 and the disk device 133 are not limited to the respective numbers shown in FIG. 1. The storage device is also not limited to the number shown in FIG. 1.

The storage controller 132 communicates with the server 100 and controls the storage device 130. Specifically, the storage controller 132 communicates with the server 100, and, in accordance with a request from the server 100, either writes data to the disk device 133 while using the below-described storage cache 131, or reads data from the disk device 133 while using the storage cache 131. As described above, it is supposed that either an access request received by the storage controller or data sent from the storage controller targets block data (may simply be called a block) specified in accordance with a block-address format.

The storage cache 131, for example, is a semiconductor memory, and is used for temporarily storing either data to be written to the disk device 133 or block data read out from the disk device 133. Furthermore, a storage device that is slower than the semiconductor memory may be used as part of the storage cache.

The disk device 133 is for storing data. In FIG. 1, the storage device 130A has two disk devices 133A, and the storage device 130B has two disk devices 133B, but an arbitrary number of disk devices 133 are able to be installed in the storage device 130. The typical disk device 133 is an HDD, but the disk device 133 may also be a device other than an HDD as long as the device is able to store block-format data, and, for example, may use a DVD, CD or Solid State Disk (semiconductor disk) instead.

Furthermore, for reasons of increasing speed, achieving redundancy and enhancing reliability, the storage controller may implement processing (more specifically, processing disclosed in RAID technology) for treating a plurality of disk devices 133 as one or more virtual disk devices and providing access to the server 100. In the explanation below, this virtual disk device will be called a volume, and in a case where the explanation states that “either the storage device or the storage controller writes block data to the volume”, this actually signifies that the storage controller 132 writes block data to either the storage cache 131 or the data device 133. Similarly, in a case where the explanation states that “either the storage device or the storage controller reads block data from the volume”, this actually signifies that the storage controller 132 reads block data from either the storage cache 131 or the data device 133. In general, upon receiving a request from the server 100 to write data to the volume, the storage controller 132 temporarily writes the data to the storage cache 131, which has a fast access speed, and thereafter notifies write-complete to the server 100. Then, by writing the data stored in the storage cache 131 to the disk device 133 asynchronously to the write request from the server, the storage controller 132 maintains the enhanced performance of the storage device 130 as a whole even when the performance of the disk device 133 is lower than that of the storage cache 131.

An FC 103 between the adapter 108 of the server 100 and the storage controller 132 of the storage device 130 may be connected via a switch. Also, a plurality of storage devices 130 may be connected to the server 100. Further, the server 100 and the plurality of storage devices 130 may also configure a storage area network (SAN). In FIG. 1, a plurality of clients 110 are connected to one LAN 101, but a connection mode other than this may also be used. Similarly, the server 100 is connected to the management machine 120 by way of the LAN 102, but the LAN 101 and the LAN 102 may also be a common network.

The communication path 103 between the adapter 108 and the storage device 130, for example, is considered to be a fibre channel (FC) connection, but as long as communication is possible, a communication medium other than this (for example, the Ethernet) may be utilized.

In FIG. 1, the configuration is such that the server 100 is connected to individual storage devices 130, but the configuration may also be such that a plurality of servers 100 connects to one storage device 130.

FIG. 2 is a block diagram showing the configuration of the programs and the information of the present invention, and the relationships between the hardware and these programs and data.

Explanations of elements assigned the same numbers as in FIG. 1 will be omitted.

A file operation notifying program 200 and a plurality of virtual file servers 220 are stored in the memory 107 of the server 100. As described hereinabove, these are executed and run by the CPU 106.

The virtual file server 220 has a program and information required for providing a server. The virtual file server 220 comprises an application 221 (App in FIG. 2) and a mount table 222.

The application 221 is a program such as a file server for providing the virtual file server 220 to the client 110. A plurality of different types of applications 221 may also be inside a single virtual file server 220. For example, a file server that supports the NFS (Network File System) protocol, and a file server that supports the CIFS (Common Internet File System) protocol may be provided using a single virtual file server 220. The same type application 221 may reside on different virtual file servers 220 inside a single server 100, and the same file sharing service may be provided simultaneously.

Furthermore, it is supposed that a virtual file server in accordance with the present invention also comprises parts realized in the related art, and has all of the following characteristic features below. However, even if a virtual file server does not have a portion of these characteristic features, it may still reap the benefits of the present invention (For example (D) and (G)). (A) Each virtual file server is allocated at least either any one or a portion of the CPU 106, the memory 107, the adapter 108, the NIC 104 and the NIC 105 (any of which may be a plurality) of the file server (in a case where there is only a CPU 106, an NIC or an adapter, this may signify a portion of a time-divided time slice, and in a case where there is only one of the memory, this may signify a portion of the total capacity allocated in accordance with either spatial division or the dividing up of the utilization capacity), and uses these components to provide a file sharing service. Furthermore, the provision of the file sharing service includes the provision of file creating, updating, deleting, and attribute changing, directory creating, updating, deleting and attribute changing, the provision of a file name space in which a file or directory is include, and the provision of an operation, and may also include services other than these. These provided items may be replaced with an operation required to provide the object-format access typified by XAM, and may also be replaced by an operation required for another protocol. (B) To provide a file sharing service, each virtual file server has an individual IP address. Consequently, from the client 110 side, it appears that each virtual file server exists physically as a separate machine. (C) To provide a file sharing service, the file name space provided by each virtual file server is different. In other words, each virtual file server provides as the file name space a different partial space of the file name space that the server 100 has stored in the storage device 130 volume. (D) To provide a file sharing service, each virtual file server has a user group that corresponds to an independently provided file name space, and implements access control based on the relevant user. (E) To provide a file sharing service, each virtual file server is able to individually implement setting management. Examples of setting management may include a settings related to the above-mentioned user, and a setting related to the CPU 106, the memory 107, the adapter 108, the NIC 104 and the NIC 105 being used by the virtual file server (for example, the allocation of an IP address). (F) In the file sharing service and the management described in (E), the virtual file servers do not use a CPU 106, a memory 107, an adapter 108, a NIC 104 or a NIC 105 that has not been allocated. Consequently, security assurance and performance guarantees are realized. (G) Each virtual file server may have either the identification information of one or more clients, which permit utilization of the individually provided file sharing services (may also be expressed as permitting access to the file name space provided by the virtual file server), or the identification information of one or more clients that restrict the use of this service, and may enforce access control.

Furthermore, the case may be one in which the CPU 106, the memory 107, the adapter 108, the NIC 104 and the NIC 105 allocated in (A) are implemented such that their allocation does not change except for a setting change in accordance with (E), or one in which the allocation status changes dynamically for a portion of the parts. For example, when there is a surplus of memory 107, there may be a case in which this surplus is automatically allocated to the virtual file server, or a case in which a substitute part is utilized when a part malfunction is either detected or anticipated, but another reason may also apply.

With regard to the settings for each virtual file server in (E), a password may used for authentication prior to carrying out an original management IP address and management operation in each file server. However, if information capable of specifying each virtual file server is sent from the management machine as a substitute for an IP address, the password may be replaced with the other information. As one example of this, there may be a process that makes it possible to input an authentication-targeted virtual file server into a common server 100 authentication screen.

A volume 134 is a virtual disk device that the storage device 130 provides to the server 100. The storage controller 132 partitions the plurality of disk devices 133 inside the storage device 130 into one or more virtual disk devices using RAID technology to create the volume 134.

The mount table 222 is information for storing the correspondence between the identification information of a file system 210 that stores data used by the application 221 and the identification information of the volume 134 that stores the file system. The mount table 222 may store the identification information of a plurality of file systems 210 and the identification information of a plurality of volumes 134. The application 221 uses the volume 134 whose identification information is stored in the mount table 222 to provide a service to the client 110. When the application 221 accesses files in the file system, the application 221 can specify the volume 134 to be accessed with reference to the mount table 222.

A shared memory 240 is a shared area in the memory 107 used for communications between the virtual file server 220 and the file operation notifying program 200. There is one shared memory 240 for each virtual file server 220, and the virtual file server 220 and the file operation notifying program 200 are both able to read and write from and to this memory 240. There may also be a plurality of shared memories 240 for a single virtual file server 220.

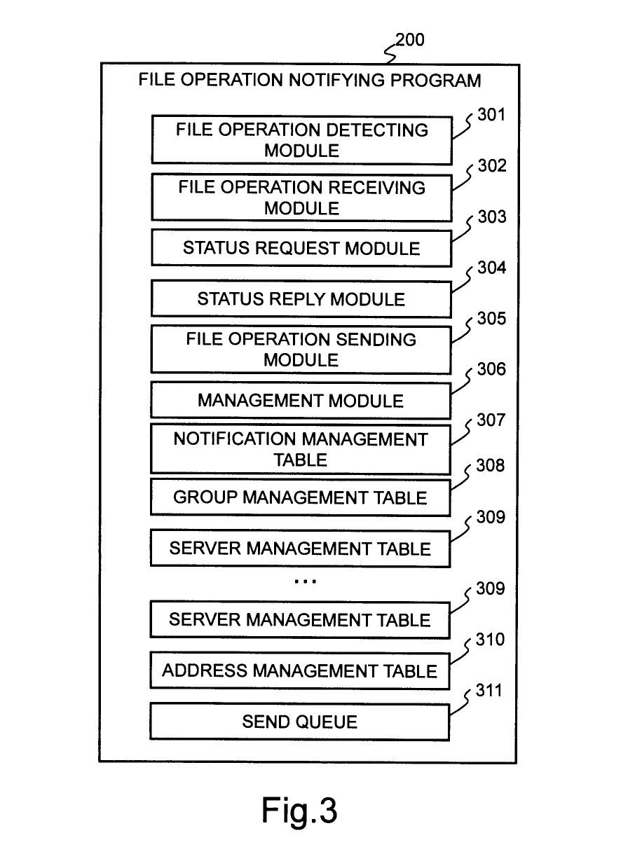

The file operation notifying program 200 is for detecting a request issued when the virtual file server 220 is going to access data stored in the storage device 130, and for notifying this information to the other virtual file servers 220 based on this request. FIGS. 3 through 13 show details of the operational flow and stored information of the file operation notifying program 200.

A management program 230 is stored in the memory 123 of the management machine 120.

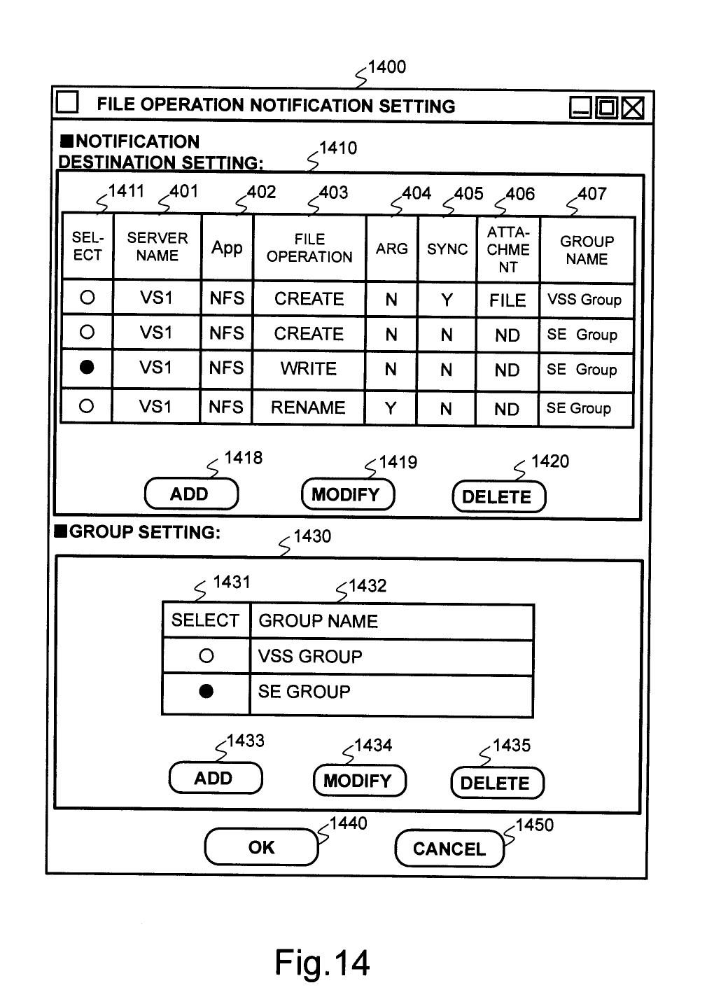

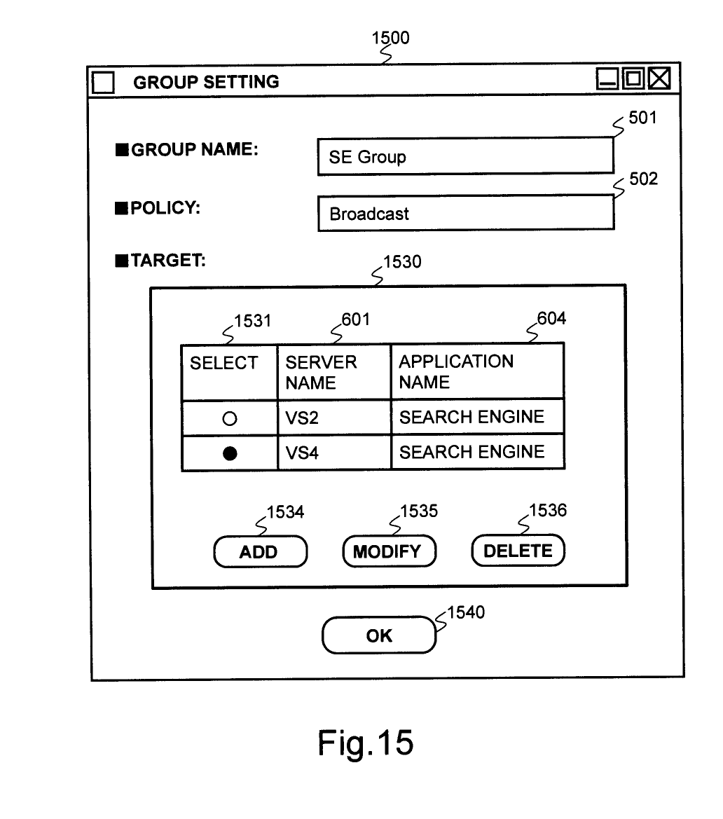

The management program 230 issues an instruction to the file operation notifying program 200 of the server 100 based on an instruction from the system administrator. Specifically, the management program 230 requests a setting for the file operation notifying program 200. FIGS. 14 and 15 show examples of management using this management program 230.

Arrows 250 through 254 are used here to show communications between the programs, and the contents of the communications and the interfaces used in communication between the respective programs will be explained.

Communication 250 shows data communications sent and received between the program on the client 110 and the application 221. The communication path of 250 uses the LAN 101. The communication protocol between the client 110 program and the application 221 utilizes a protocol unique to each application 221, such as NFS, CIFS, HTTP (Hyper Text Transfer Protocol) and FTP (File Transfer Protocol). In accordance with 250, an I/O request is sent from the client 110 program to the application 221, and the result thereof is sent back to the client 110 program.

Communication 251 shows a communication comprising a file operation between the application 221 and the file operation notifying program 200, and the return value of this file operation. File operation denotes an operation and a return value with respect to a file, such as a file create (CREATE), a file write (WRITE), and a file attribute change (SET_ATTR). The communication path of 251 uses the memory 107. Further, one example of the 251 interface uses a system call that the OS provides as standard. The file operation notifying program 200 receives the file operation of the application 221 via 251, notifies the application 221 on the other virtual file server 220 only when the file operation requires a notification, and transfers the file operation itself to 254.

Communication 252 and communication 256 depict the file operation generation notification from the file operation notifying program 200 to the application 221 and the communication of the return value. The communication paths for 252 and 256 use the memory 107. An example of the communication steps of the file operation notifying program 200 and the application 221 will be described below. The file operation notifying program 200 writes the contents to be notified to the application 221 to the shared memory 240, which is a specific area inside the memory 107 (communication 252). Next, the application 221 on the virtual file server 220 acquires the notification content addressed to its own application 221 from the shared memory 240, and writes a notification content reply to the shared memory 240 as a return value (communication 256). Next, the file operation notifying program reads the application 221 return value from the shared memory 240 (communication 252). Further, a socket file is used as an example of an interface for communicating using the shared memory 240. Specifically, it is a system in which a virtual file system is configured in the shared memory 240, a communication socket file is provided in the virtual file system, the file operation notifying program 200 and the application 221 mutually share the socket file, and the file operation notifying program 200 and the application 221 carry out communications using a socket interface.

Communication 253 depicts a file operation notification between file operation notifying programs 200 on different servers 100. The communication path of 253 uses the LAN 102. Further, the communication protocol between the file operation notifying programs 200 uses a TCP- or UDP-based protocol. The file operation notifying program 200 notifies the application 221 on the virtual file server 220 of an external server 100 of the generation of a file operation via 253.

Communication 254 depicts a disk I/O between the file operation notifying program 200 and the storage device 130. The communication path of 254 uses the FC 103. The file operation notifying program 200 relays a file operation (system call) from the application 221, transferring this file operation to the storage device 130. At the time of the transfer, the file operation notifying program 200 also converts the file operation instructed from the application 221 to a SCSI command and sends this command to the storage device 130.

Communication 255 depicts a management communication between the management program 230 and the file operation notifying program 200. The 255 communication path uses the LAN 102. Further, communication with the file operation notifying program 200 uses a TCP- or UDP-based protocol. In accordance with 254, a setting change request is sent from the management program 230 to the file operation notifying program 200.

FIG. 2 will be used here to explain the flow of processing in a case where the client 110 issues a file write request to the file sharing service (application 221) being provided by VS1 (virtual file server 220), and this file operation notification is sent to the VS3 (virtual file server 220) application 221.

The file write request from the client 110 to the file system 210A reaches the VS1 of the server 100A by way of the LAN 101 (communication 250).

The VS1 file sharing service receives the request from the client 110, and issues a WRITE system call for writing this request to the file (communication 251). At this point, the file operation notifying program 200A detects the WRITE system call of the file sharing service, and notifies the file operation notifying program 200B via the LAN 102 in a case where it has been determined that a notification to the VS3 application 221 is required (communication 253).

The file operation notifying program 200B receives the information that the VS1 file sharing service has issued a file operation. Next, the file operation notifying program 200B writes the fact that the VS1 file sharing service has generated a file operation to the shared memory 240 (communication 252). Next, the VS3 application 221 receives the notification content from the shared memory 240, and writes a notification content reply to the shared memory 240 as a return value (communication 256). Next, the file operation notifying program 200B fetches the return value from the shared memory 240 (communication 252). Next, the file operation notifying program 200B sends the fetched return value back to the source file operation notifying program 200A as a reply (communication 253).

Meanwhile, subsequent to notifying the file operation notifying program 200B of the generation of the file operation, the file operation notifying program 200A executes the WRITE system call from the file sharing service. Specifically, the file operation notifying program 200A specifies the volume 134A that corresponds to the file system 210A from the mount table 222, issues a write request (SCSI command) to the volume 134A, and receives the write result (communication 254). The file operation notifying program 200A returns the WRITE system call result to the file sharing service (communication 251).

The file sharing service, after a successful write to the volume 134A, returns a write-successful return value to the client 110 by way of the LAN 101 (communication 250).

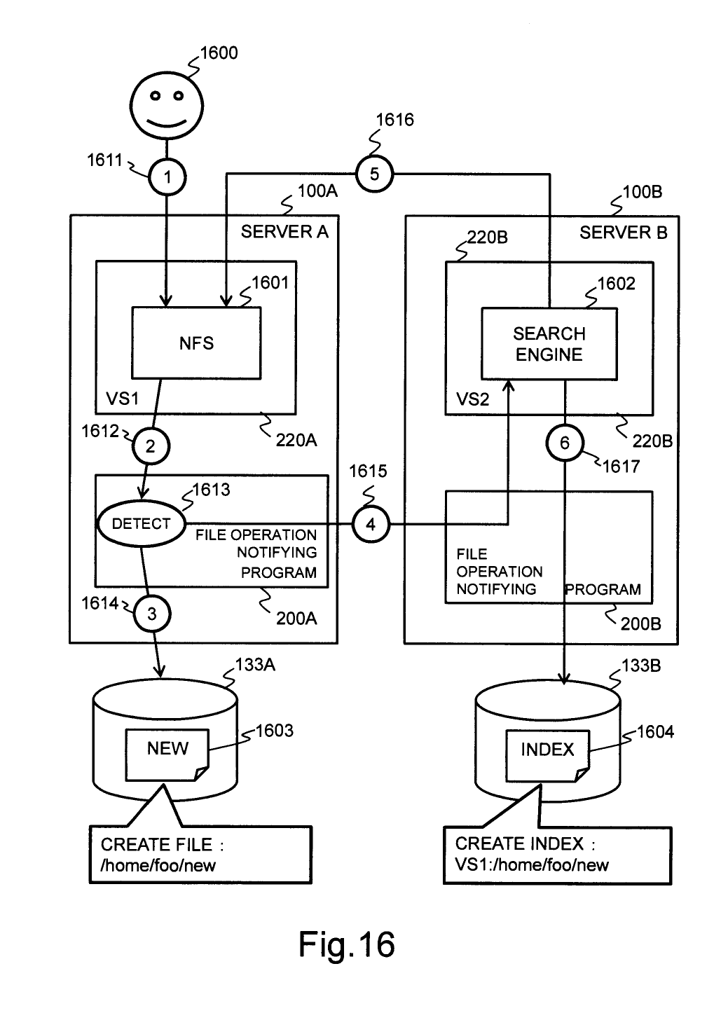

Next, an overview of the present invention will be explained using the schematic diagram of FIG. 16. Furthermore, the items explained in this overview are simply examples, and the scope of the present invention are not limited thereto.

The spread of information system utilization methods and the widespread use of information equipment have resulted in extremely large amounts of files stored on file servers.

For this reason, most file servers used in a shared fashion by large numbers of people make combined use of search engines for finding a certain target file from among a large number of files, a backup server for replicating and storing files, and a remote copy server for replicating files at remote locations in preparation for a disaster.

A server that is used simultaneously with these file servers executes a service by using the file update information of the file servers. For example, the search engines must change the search index information when a file is updated. The backup server and the remote copy server also perform processing for selecting only a backed up file when deleting replicated information.

However, in a case where a file that has been managed by the file server up until this time is updated in accordance with a request from the client, all the files stored in the file servers of the respective servers had to be regularly scanned and checked for changes because mutually linked operations such as notifying a notification of this file update to the application on the other virtual file server inside the server machine and to the application on an external server machine were not possible.

By notifying file server update information to other servers, the present invention does not require regular scans, realizing a reduction of the load on the storage device that stores this file server and the data.

FIG. 16 is a diagram schematically showing the relationship between the virtual file server (may also be called VS hereinafter) 220 of the present invention and an example of the operation of the file operation notifying program.

In FIG. 16, a server 100A carries out file access service processing in accordance with a NFS service in a virtual file server 220A. Further, a server 100B carries out search service processing in a virtual file server 220B.

The server 100 has file operation notifying programs 200, detects a file update, determines whether or not a notification of this file update to the other virtual file server is required, and, in a case where it is determined to be required, notifies information related to this file update to the file operation notifying program 200 of the other server 100. The file operation notifying program notifies the file update information to the service (application) being processed on the virtual file server 220.

When using the file operation notifying program 200, the corresponding relationship between the service (application) about which notification is to be made and the notification-destination service (application) is registered beforehand in the file operation notifying program 200. The file operation notifying program 200 determines the need for a file update notification based on this registration. In the example of FIG. 16, the registration shows the file system in which the server 100A is implementing the NFS service 1601 as the notification target, and the notification destination as the search engine 1602 of the server 100B that is executing the search service of the NFS service 1601. Further, the search engine 1602 has been set so as to be accessible to the NFS service 1601, which is the search target.

FIG. 16 shows an example in which the file stored in the NFS service provided by the server 100A is searchable by the search service provided by the server 100B.

The client requests the NFS service of the server 100A for a data update (1611). The data update request from the client is issued as a NFS protocol WRITE request in this example. Other protocols for updating data besides that of the NFS service include CIFS, HTTP and FTP.

The virtual file server 220A, which received the update request, executes the NFS service 1601 as a file change request to the storage device (1612). The request from the client is processed by the NFS service 1601 on the virtual file server 220A as a system call to the file system.

The file operation notifying program 200A, upon detecting that this request is a file update request, temporarily stores this information, and executes file 1603 update processing to the storage device (1614). The file operation notifying program 200 monitors the system call issued by the virtual file server 220, and if it is a WRITE system call to the file system corresponding to the NFS service 1601, determines that an update notification is required, and detects the WRITE system call as a file update. A system call other than the WRITE system call, such as a CREATE system call for creating a new file and a SET_ATTR system call for changing a file attribute, may also be included as detection targets. Further, the file 1603 update process to the storage device is converted to a SCSI command for storing data from the system call to a block of the storage device.

The file operation notifying program 200A notifies the information of the temporarily stored file update request to the search service 1602 of the virtual file server 220B by way of the file operation notifying program 200B of the server 100B (1615). This notification is performed between the file operation notifying programs 200 using a dedicated file operation notifying program 200 protocol of the TCP/IP, which is the network protocol. The notification between the file operation notifying program 200B, which received the notification, and the search engine 1602 is carried out by providing the server with a dedicated notification interface.

The search service 1602, which received the file update notification from the file operation notifying program 200B of the server 100B, acquires the updated file for the NFS service 1601 of the server 100A based on the file information included in the notification (1616). The acquisition of data by the search engine 1602 is executed based on the NFS protocol the same as the client connected to the file server 100A.

The search engine 1602 updates the index information for the search service based on the acquired file (1617). The index for the search service is a database of metadata of search-targeted files, and data keywords included in the files. For example, in a case where a file search is conducted based on the file creation time and the file creator, it is possible to search to determine if this information is included in the metadata information. Further, if a database of data keywords included in the files is utilized, specifying a certain keyword makes it possible to retrieve a file that includes this keyword.

In this way, the search engine 1602 is able to update the index information used in the search service based on the information in the notification by the file operation notifying program 200. The above-mentioned usage case is merely an example, and the scope of the present invention is not limited to this application. The present invention will be explained in detail hereinbelow.

FIG. 3 shows a file operation notifying program 200.

The file operation notifying program 200 has a file operation detecting module 301; a file operation receiving module 302; a status request module 303; a status reply module 304; a file operation sending module 305; a management module 306; a notification management table 307; a group management table 308; a server management table 309; an address management table 310; and a send queue 311.

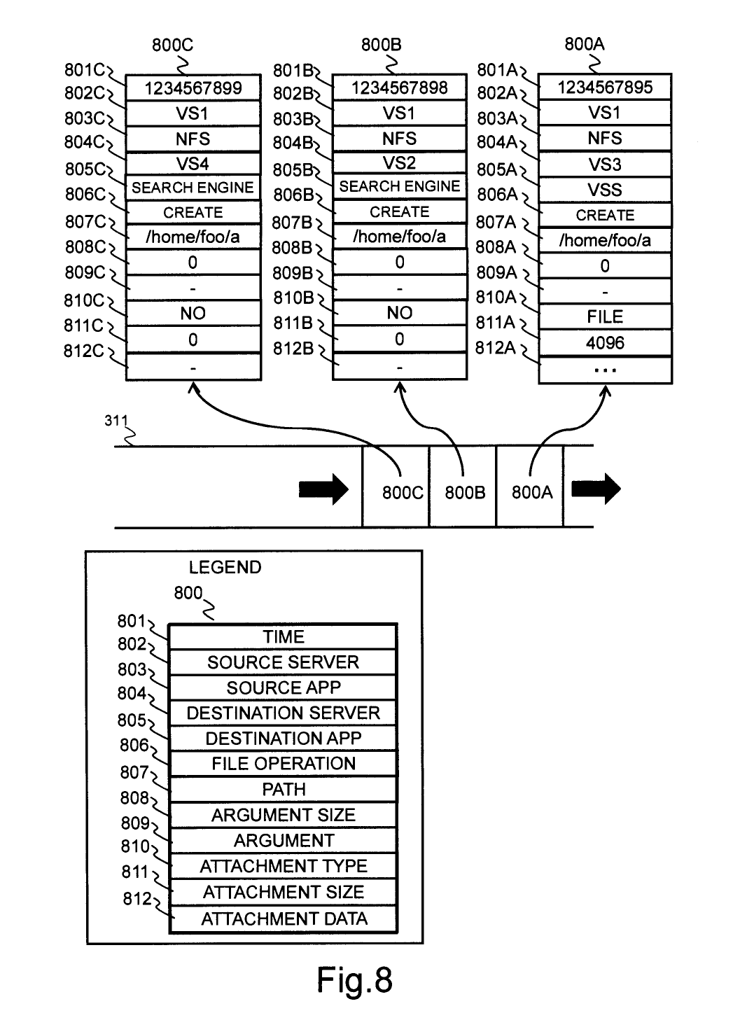

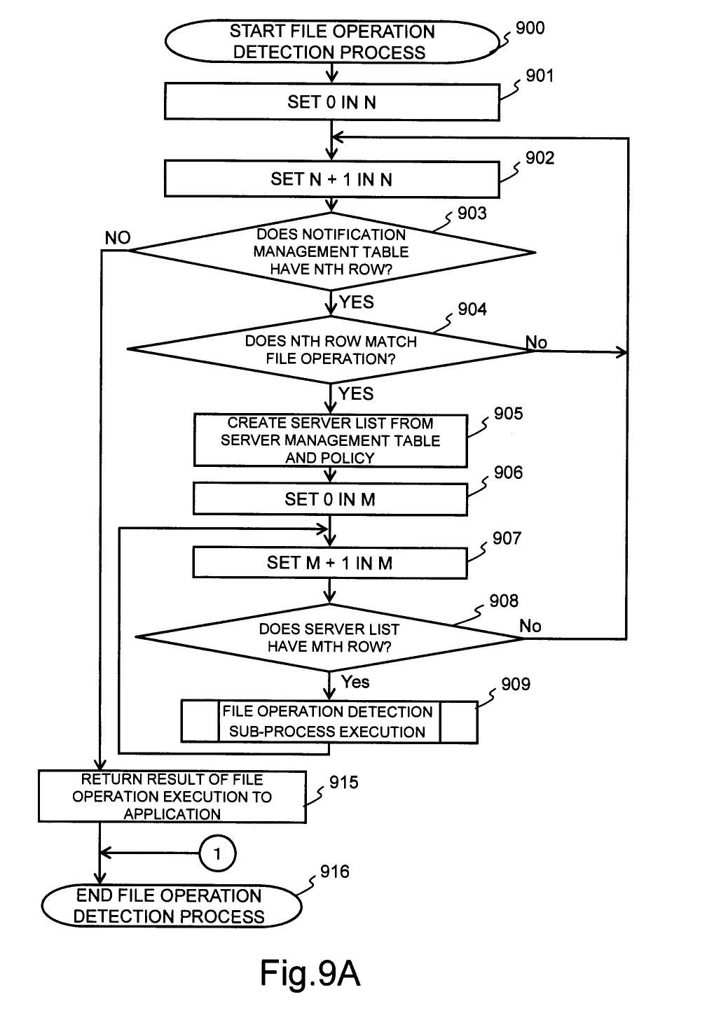

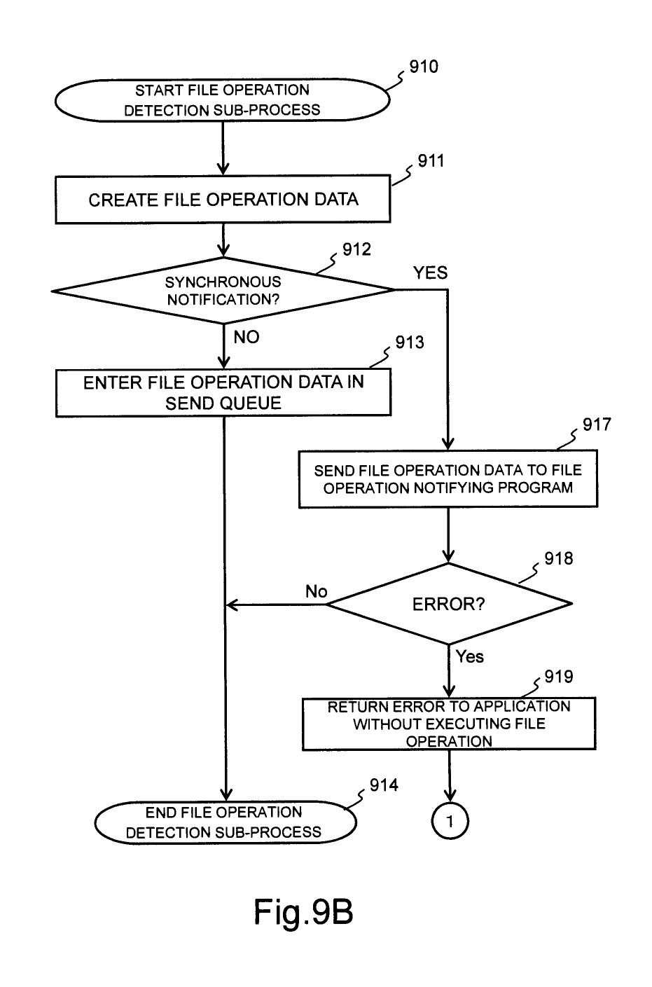

The file operation detecting module 301 is a program for detecting that the application 221 of a certain virtual file server 220 inside the server 100 has issued a file operation to the file system 210 of the volume 134, creating file operation data 800 based on the notification management table 307, the group management table 308 and the server management table 309, and either entering the above-mentioned file operation data 800 into the send queue 311 or notifying the above-mentioned file operation data 800 to the directly specified file operation notifying program 200. FIG. 8 shows the details of the file operation data 800. FIG. 9 shows the flow of processing of the file operation detecting module 301.

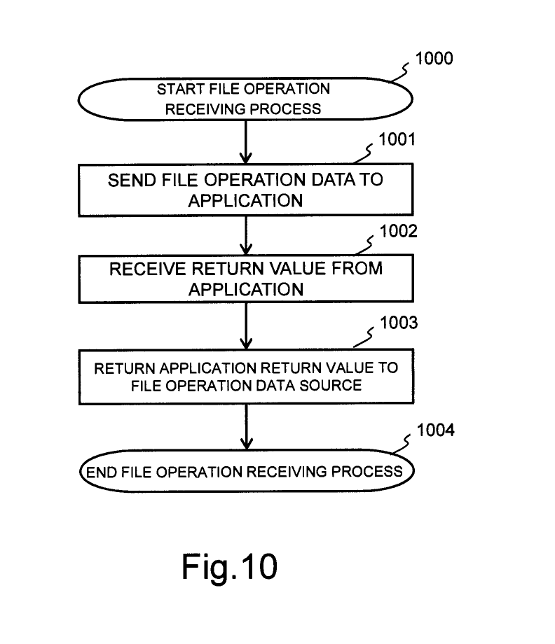

The file operation receiving module 302 is a program for receiving the file operation data 800 that either the file operation detecting module 301 or the file operation sending module 305 has sent to the file operation notifying program 200, and notifying the application specified in the file operation data 800. FIG. 10 shows the flow of processing of the file operation receiving module 302.

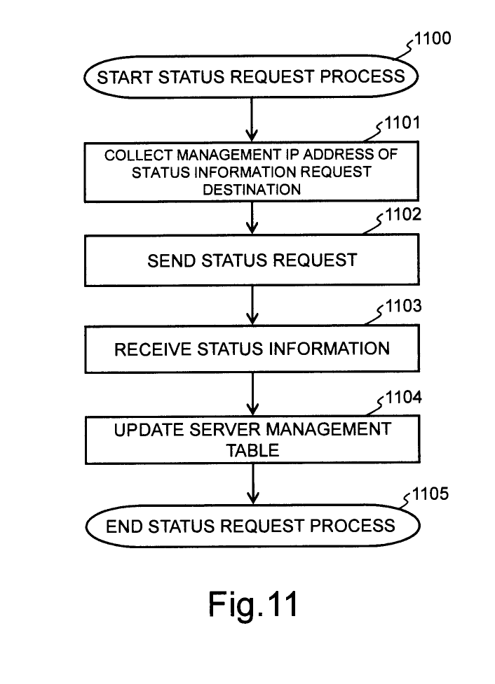

The status request module 303 is a program for requesting the file operation notifying program 200 of a specified server 100 for status information, such as the CPU load information or the I/O load information of the server 100 based on the group management table 308 and the server management table 309. FIG. 11 shows the processing flow of the status request module 303.

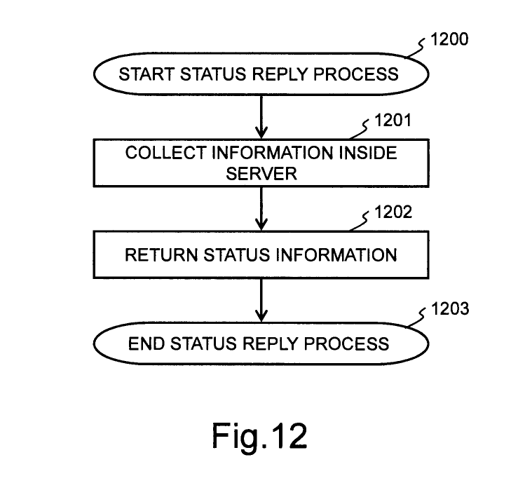

The status reply module 304 is a program for collecting the status information from inside the server 100 and replying with this status information in a case where the status request module 303 has requested the file operation notifying program for status information. FIG. 12 shows the processing flow of the status reply module 304.

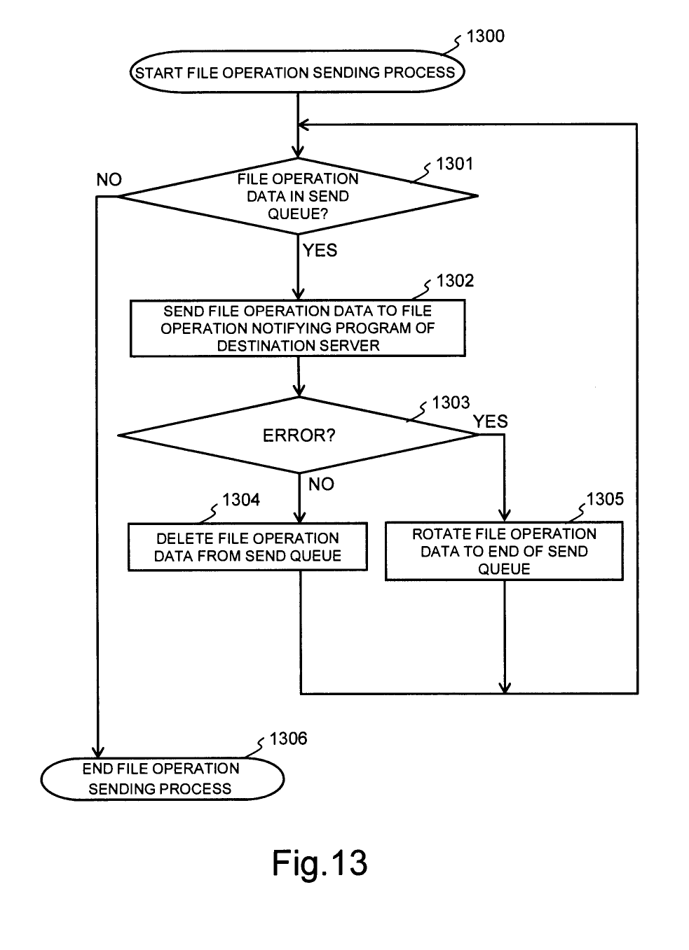

The file operation sending module 305 is a program for regularly checking the send queue 311, and when file operation data 800 is being queued, notifying this file operation data 800 to the specified file operation notifying program 200. FIG. 13 shows the processing flow of the file operation sending module 305.

The management module 306 is a program for carrying out file operation notifying program settings in a linked manner with the management program 230. FIGS. 14 and 15 show an example of the setting screen that the management program 230 provides to the system administrator, and the linkage processing of the management module 306.

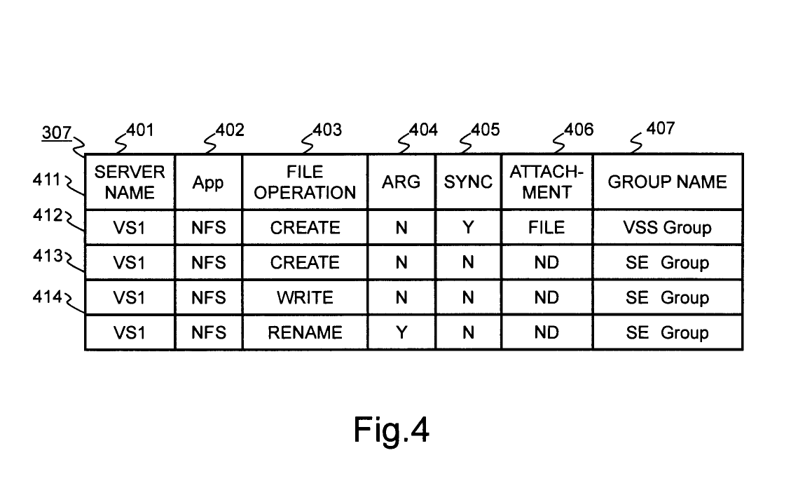

The notification management table 307 is for managing the application targeted for monitoring by the file operation notifying program 200, the file operation, and the file operation notification destination. FIG. 4 shows details of the notification management table 307.

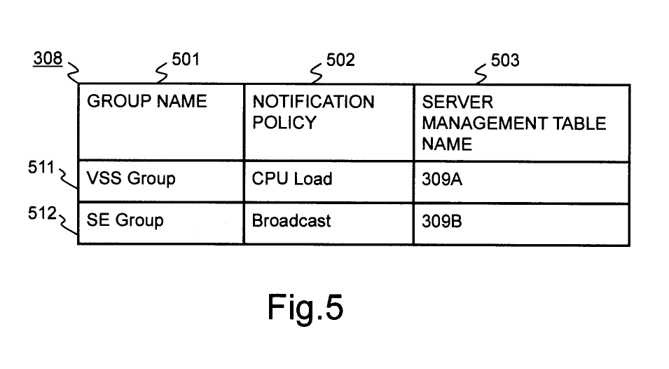

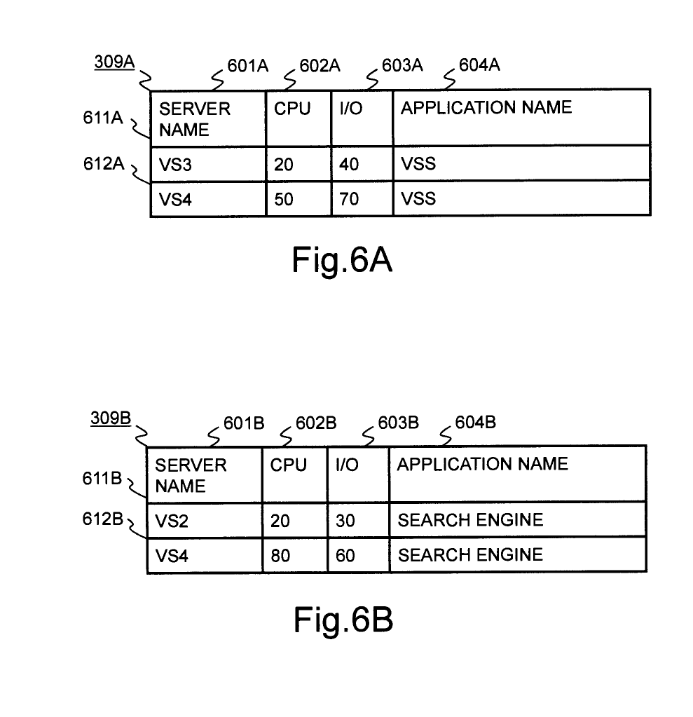

The group management table 308 is for managing the destination and notification policy of the file operation data 800. The group management table 308 has a server management table 309 as a sub-table for grouping and managing a plurality of virtual file servers 220 constituting the destination of the file operation data 800. The server management table 309 is for managing the information of the applications 221 of the plurality of virtual file servers 220 constituting the destination of the file operation data 800. FIG. 5 shows details of the group management table 308. FIG. 6 shows details of the server management table 309.

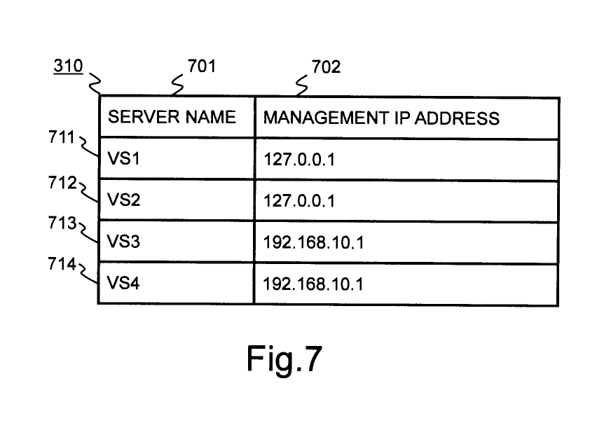

The address management table 310 is for managing the IP address of the relay file operation notifying program 200 when sending the file operation data 800 to an application 221 on a specified virtual file server 220. FIG. 7 shows the details of the address management table 310.

The send queue 311 is a queue-type data structure in which the file operation detecting module 301 temporarily stores the file operation data 800. The file operation data 800 stored in the send queue 311 is fetched by the file operation sending module 305 and sent to the file operation notifying program 200 of the server 100 specified in the file operation data 800. FIG. 8 shows the details of the send queue 311.

The preceding has been an explanation of the programs, tables and data structure of the file operation notifying program 200.

FIG. 4 shows the notification management table 307.

The notification management table 307 is for managing the settings of the file operation notifying program 200. The respective file operation notifying programs 200 have a single notification management table 307.

Rows 411 through 414 of the notification management table 307 show the type of file operation detected for each application 221 of the respective virtual file servers 220, the mode for notifying the information of the detected file operation, and the notification destination of the file operation.

A server name 401 column holds the identifier of the host name of the virtual file server 220 targeted for monitoring by the file operation notifying program 200.

An application name 402 (App in FIG. 4) column holds the specifiable identifier of an application 221 being executed on the virtual file server 220, such as the name and process ID of the application 221 targeted for monitoring by the file operation notifying program 200.

A file operation 403 column holds the file operation type of the application name 402 in the server name 401 targeted for monitoring by the file operation notifying program 200. Specifically, the file operation 403 column specifies a file write (WRITE), a file read (READ), a new file create (CREATE), a file pathname change (RENAME), and a file delete (UNLINK). However, the above file operation types 403 are merely examples, and the scope of the present invention is not limited thereto.

An argument flag 404 (arg in FIG. 4) column holds a flag denoting whether or not the file operation data 800 comprises a file operation (system call) argument. In FIG. 4, a case in which “Y” is stored denotes that an argument is included, and a case in which “N” is stored, denotes that an argument is not included. Furthermore, the argument flag 404 notation method is an example, and the scope of the present invention is not limited to this mode.

The synchronous flag 405 (sync in FIG. 4) column holds a flag denoting if the notification of a file operation detected from an application 221 of the application name 402 will be executed synchronously or asynchronously. In the case of a synchronous execution, the processing of the application 221 of the application name 402 is blocked until the file operation data 800 has been sent to the group specified by a group name 407 and the result thereof returned. In a case where this result is a timeout, an error is returned to the application 221 that has performed the targeted file operation. In the case of an asynchronous execution, the file operation data 800 is stored in the send queue 311, and the processing of the application 221 of the application name 402 is not blocked. In FIG. 4, in a case where a “Y” is stored in the synchronous flag 405 column denotes synchronous, and a case where “N” is stored denotes asynchronous. Furthermore, the synchronous/asynchronous notation method is an example, and the scope of the present invention is not limited to this mode. FIG. 9 shows the details of processing in accordance with a synchronous flag.

An attachment type 406 (attachment in FIG. 4) column holds the type of data that is attached to the file operation data 800. Specifically, File and ND (no data) are specified. However, the above-mentioned attachment type 406 is merely an example, and the scope of the present invention is not limited thereto. An example of the data utilization method specified in the attachment type 406 will be described here. By attaching a file to the file operation data 800 at the time of a CREATE operation and notifying a virus scan server, it becomes possible for the client 110 to perform a virus check of the created file via the application 221.

The group name 407 column holds the name of the group of the application 221 for which the file operation is to be notified. A group comprises applications 221 inside a plurality of virtual file servers 220. FIGS. 5 and 6, which will be explained further below, show the details of a group.

The file operation notifying program 200 checks each row of the notification management table 307 to see if the detected file operation matches the server name 401, application name 402 and file operation 403, and performs file operation notification processing for the group name 407 of the matching row. Further, in a case where the detected file operation matches the server name 401, application name 402 and file operation 403 of a plurality of rows inside the notification management table 307, the file operation notifying program 200 performs the notification process for the group names 407 of the respective rows. For example, in the case of FIG. 4, when the NFS server of the VS1 issues the file operation CREATE, the file operation notifying program 200 detects the file operation, checks rows 411 through 414 of the notification management table 307 to determine if there is a row that coincides with the issued file operation, and performs file operation notification processing for the coinciding VS Group of row 411 and the SE Group of row 412. FIG. 9 shows details of processing in which the notification management table 307 is scanned by the file operation notifying program 200.

The preceding has been an explanation of the notification management table 307. Furthermore, the notification management table 307 may be managed manually by the system administrator using the examples of setting windows in FIGS. 14 and 15, which will be explained further below, and may also be automatically updated at the time an application 221 is installed. For example, when a search engine is installed in a certain server 100, the notification management table 307 may be automatically updated such that an operation in which the NFS server inside the server 100 writes a file is notified to the group of the newly installed search engine.

FIG. 5 shows the group management table 308.

The group management table 308 is for managing the setting information of a group.

Rows 511 through 512 of the group management table 308 show the respective group settings.

A group name 501 column holds an identifier that groups together the applications 221 of a plurality of virtual file servers 220 that constitute the destinations of the file operation data 800.

A notification policy 502 column holds the policy for notifying an application 221 inside a group. Specifically, the notification policy 502 column specifies Broadcast for notifying all the applications 221 inside a group; Round-Robin for notifying a plurality of applications 221 inside a group in order; CPU Load for notifying the virtual file server 220 application 221 having the lowest CPU load; and I/O Load for notifying the virtual file server 220 application 221 having the lowest I/O load. However, the above notification policy 502 types are merely examples, and the scope of the present invention is not limited thereto.

A server management table name 503 column holds the identifier of the server management table 309 corresponding to the group name 501. FIG. 6 shows details of the server management table name 503.

For example, the SE Group notification policy for the row denoted by 512 in FIG. 5 is Broadcast, signifying that the file operation data 800 is to be sent to all of the applications 221 on the virtual file server 220 managed by the server management table 309B.

The group configuration policy and selection policy for the notification policy 502 are shown here. For example, in a case where the processing for a file operation is executed by balancing the load among a plurality of applications 221, the system administrator configures the same type applications 221 into a group, and sets Round-Robin, CPU Load or I/O Load as the notification policy 502. The CPU Load and I/O Load settings in particular are used in a case where the CPU load or I/O load to be requested by the application 221 is known to be large, and processing is to be executed by an application 221 on a server 100 that has more than enough capacity to handle the CPU load or I/O load. Applications 221 that perform load balancing include a virus scan server and backup server.

In a case where it is necessary to collect together the notifications for a single file operation and notify a plurality of applications, the system administrator configures a single group from the plurality of applications to be collectively notified, and sets Broadcast as the notification policy 502. For example, in a case where a file update is to be notified to a search engine in a system that distributively manages search indexes with a plurality of search engines, Broadcast is used to notify the file update to all the search engines. Each search engine receiving the file update determines on its own whether or not it is necessary to update the search index that it manages, and only a search engine that requires updating carries out processing.

The preceding has been an explanation of the group management table 308. The group management table 308 may be managed manually by the system administrator using the setting window examples of FIGS. 14 and 15, which will be explained further below, and may also be automatically updated at the time an application 221 is installed. For example, when a new search engine is installed, the group management table 308 and the server management table 309 shown in FIG. 6 may be automatically checked, and when the group to which the newly installed search engine belongs does not exist, a new search engine group (to include a server management table 309) is automatically created and registered in the group management table 308. As an example of the system administrator carrying out management manually, there could be a case in which Round-Robin was set in the notification policy 502, but a bias occurred in the CPU load or I/O load between a plurality of notification destination servers 100, and the notification policy 502 is manually changed to CPU Load or I/O Load.

FIGS. 6A and 6B show the server management table 309.

The server management table 309 is for managing information on the virtual file server 220 that configures the notification-destination group and the application 221. The file operation notifying program 200 has one server management table 309 for each group managed by the group management table 308. Furthermore, FIG. 6A is the server management table 309A of the VSS Group and FIG. 6B is the server management table 309B of the SE Group, which were denoted as server management table names 503 in FIG. 5.

Rows 611A and 612A of server management table 309A and rows 611B and 612B of server management table 309B show information on the virtual file server 220 and the applications running on the above-mentioned virtual file server 220.

A server name 601 column holds an identifier, such as a host name of a virtual file server 220.

A CPU load 602 column holds CPU load information for a server name 601. In FIG. 6, the proportion of the CPU load is displayed as a percentage.

An I/O load 603 column holds I/O load information for a server name 601. In FIG. 6, the proportion of the I/O load is displayed as a percentage.

An application name 604 column holds an identifier for identifying an application 221, such as a program name or a process ID, being executed on the virtual file server 220 denoted by the server name 601.

For example, the row denoted by 611B in FIG. 6 signifies that the application 221 included in the SE Group is a search engine running on VS2, and that the CPU load of VS2 is 20% and the I/O load on VS2 is 30%.

The preceding has been an explanation of the server management table 309. Furthermore, this embodiment shows information about the CPU load 602 and the I/O load 603 as information related to the server name 601 stored in the server management table 309, but these two pieces of information are merely examples, and the scope of the present invention is not limited thereto. The present invention may also be put into practice by additionally storing information required for realizing the notification policy 502 of the group management table 308 in the server management table 309. The server management table 309 may also be managed manually by the system administrator using the examples of the setting windows of FIGS. 14 and 15, which will be explained further below, and may also be created automatically at the time an applications 221 is installed as shown in FIG. 5.

FIG. 7 shows the address management table 310.

The address management table 310 is for managing the IP address of the relaying file operation notifying program 200 when sending the file operation data 800 to the application 221 of a specified virtual file server 220.

Rows 711 through 714 of the address management table 310 show which IP address the file operation data 800 is to be sent to for each notifying virtual file server 220.

A server name 701 column holds an identifier, such as the host name of a virtual file server 220.

A management IP address 702 column holds the IP address for communicating with the file operation notifying program 200 of the server 100 on which the virtual file server 220 of the server name 701 column is running. The example shown in FIG. 7 signifies that IP address 127.0.0.1 is used for communicating with the file operation notifying program 200 of the server 100 on which the virtual file servers 220 of the VS1 and VS2 are running. Similarly, this example signifies that IP address 192.168.10.1 is used for communicating with the file operation notifying program 200 of the server 100 on which the virtual file servers 220 of the VS3 and VS4 are running.

The preceding has been an explanation of the address management table 310. Furthermore, in a case where a virtual file server 220 running on the server 100 is added or deleted, a pair comprising a server name 701 and management IP address 702 will also be added/deleted to/from the address management table 310 at the same time.

FIG. 8 is a schematic diagram of the send queue 311.

The send queue 311 is a queue-type data structure in which the file operation detecting module 301 of the file operation notifying program 200 temporarily stores in order the file operation data 800 created when a file operation is detected. The send queue 311 given as an example in FIG. 8 signifies that three file operation data 800A through 800C to be notified to the application 221 are being stored in order. Further, the content configurations of the file operation data 800A through 800C stored in the send queue 311 are shown in 801A through 812A, 801B through 812B, 801C through 812C.

The file operation data 800 comprises a time 801; a source server 802; a source application 803 (source App in FIG. 8); a destination server 804; a destination application 805 (destination App in FIG. 8); a file operation 806; a path 807; an argument size 808; an argument 809; an attachment type 810; an attachment size 811; and an attachment data 812.

The time 801 holds the time at which the file operation data 800 was created. In FIG. 8, the time 801 is stored in seconds units, but the time storage format does not limit the scope of the present invention.

The source server 802 holds the identifier of the virtual file server 220 on which the application 221 that issued the file operation is running.

The source application 803 holds the identifier of the application 221 that issued the file operation.

The destination server 804 holds the identifier of the virtual file server 220 on which the destination application 221 of the file operation data 800 is running.

The destination application 805 holds the identifier of the application 221 that is the destination of the file operation data 800.

The file operation 806 holds the type of the file operation issued by the source application 803. The file operation type specifically specifies a file write (WRITE), a file read (READ), a new file create (CREATE), a file path change (RENAME), a file delete (UNLINK) and a file attribute change (SET_ATTR). However, the above-mentioned file operations are merely examples, and the scope of the present invention is not limited thereto.

The path 807 holds the pathname of the file that is the target of the file operation.

The argument size 808 holds the size of the argument of the application 221-issued file operation. In a case where a notification is not required, 0 is specified by the argument flag 404 of the notification management table 307.

The argument 809 holds the argument of the file operation issued by the source application 803.

The attachment type 810 holds an identifier signifying the type of the attachment data 812. Specifically, File or ND (no data) is specified. However, the above-mentioned type of the data to be notified is merely an example, and the scope of the present invention is not limited thereto.

The attachment size 811 holds the size of the attachment data 812. However, in a case where “no data” is held in the attachment type 810, the size is 0.

The attachment data 812 holds the actual data, such as the file, pathname, and read/write data. However, in a case where “no data” is held in the attachment type 810, the attachment data 812 is blank.

The file operation detecting module 301 stores the file operation data 800 in the send queue 311. The file operation data 800 stored in the send queue 311 is sent to the file operation notifying program 200 on the server 100 specified from the notification management table 307, the group management table 308, the server management table 309 and the address management table 310 by the file operation sending module 305. The processing of the file operation sending module 305 will be described in detail in FIG. 13.

The preceding has been an explanation of the send queue 311. Furthermore, a plurality of send queues 311 may be prepared inside the file operation notifying program 200, and this plurality of send queues 311 may be used in accordance with the type of characteristic, such as the file operation 806, the attachment type 810 or the destination application 805. In the case of a plurality of send queues 311, the advantage is that it becomes possible to notify the file operation data 800 to the application 221 at different send intervals in accordance with the characteristic, such as the file operation 806, the attachment type 810 or the destination application 805. FIG. 8 presents a situation in which three file operation data 800A through 800C are stored in the send queue 311, but this is an example, and the storable number of file operation data 800 is not limited to three.

FIGS. 9A and 9B are flowcharts of the file operation detection process in accordance with the file operation detecting module 301.

The file operation detection process described in Steps 900 through 919 is run when the application 221 on the virtual file server 220 issuing a file operation. Furthermore, this file operation detection process specifies a file operation name, a file operation argument, a file operation-targeted filename (pathname), the name of the application that issued the file operation, and the name of the virtual file server running the application that issued the file operation. In the case of a RENAME operation, for example, the file operation argument is a pre-change and a post-change filename (pathname), and in the case of a WRITE operation, the file operation argument is write data.

(Step 900) The file operation detecting module 301 starts processing by inputting this file operation detection process-specified information.

(Step 901) The file operation detecting module 301 prepares an integer-type variable N in the memory 107, and initializes this variable N to 0.

(Step 902) The file operation detecting module 301 assigns a value of N+1 to N. In other words, when the file operation detecting module 301 starts up and initially executes Step 902, N becomes 1, and the second time the file operation detecting module 301 executes Step 902, N becomes 2, incrementing by 1 each time.

(Step 903) The file operation detecting module 301 fetches the N^{th} row of the notification management table 307. If there is an N^{th} row in the notification management table 307, processing proceeds along “Yes”. By contrast, if the notification management table 307 does not have an N^{th} row, processing proceeds along “No”.

(Step 904) The file operation detecting module 301 checks to see if the server name 401, the application name 402 and the file operation 403 of the N^{th} row match the file operation detecting module 301 input. In a case where this row matches the input, processing proceeds along “Yes”. Conversely, in a case where the row does not match the input, processing proceeds along “No”.

(Step 905) The file operation detecting module 301 creates a list of servers (hereinafter called the server list) constituting the destinations of the file operation based on the notification policy of the group that constitutes the destination of the file operation. Specifically, the file operation detecting module 301 uses the group name 407 of the N^{th} row of the notification management table 307 to fetch the group management table 308. Next, the file operation detecting module 301 acquires the notification policy 502 in the row matching the group name 407 under the group name 501 column of the group management table 308. Next, the file operation detecting module 301 lists up the row number of the server management table 309 that indicates the server corresponding to the notification policy 502, and makes a server list. The processing of the file operation detecting module 301 in accordance with the notification policy will be described below. In a case where the notification policy 502 is Broadcast, the file operation detecting module 301 simply adds all the row number of the server management table 309 to the server list. For example, the server list for FIG. 6A will be {1, 2}. In a case where the notification policy 502 is Round-Robin, the file operation detecting module 301 stores the row number of the previously specified server in the variable, and adds the row number of the next server showing this row number to the server list. For example, the server list for FIG. 6A will be {1} when the server list is created the first time, will become {2} when the server list is created the second time, and will become {1} again when the server list is created the third time due to the server management list having come full circle to return to the server specified the first time. In a case where the notification policy 502 is CPU Load, the file operation detecting module 301 searches the server management table 309 for the server having the lowest CPU Load, and adds the row number denoting the relevant server to the server list. For example, the server list for FIG. 6A will be {1}. In a case where the notification policy 502 is I/O Load, the file operation detecting module 301 searches the server management table 309 for the server having the lowest I/O Load, and adds the row number denoting the relevant server to the server list. For example, the server list for FIG. 6A will be {1}.

(Step 906) The file operation detecting module 301 prepares an integer-type variable M in the memory 107, and initializes this variable M to 0.

(Step 907) The file operation detecting module 301 assigns a value of M+1 to M. In other words, the file operation detecting module 301 increments the value of M by 1 each time Step 907 is executed.

(Step 908) The file operation detecting module 301 fetches the M^{th} element denoting the row number of the server management table 309 from the server list created in Step 905. If there is an M^{th} element in the server list, the processing proceeds along “Yes”. By contrast, if there is not an M^{th} element in the server list, the processing proceeds along “No”.

(Step 909) The file operation detecting module 301 executes a file operation detection sub-process. The file operation detection sub-process specifies the input specified by the file operation detection process, the integer N, the server name 601 in the server management table 309 denoting the row number fetched in Step 908, and the application name 604.

(Step 910) The file operation detecting module 301 inputs the information specified by this file operation detection sub-process, and starts this file operation detection sub-processing.

(Step 911) The file operation detecting module 301 creates the file operation data 800 based on the input information. The method by which the file operation detecting module 301 creates the file operation data 800 is described in more detail below. The file operation detecting module 301 stores the current time of the server 100 in the time 801, stores the inputted virtual file server name in the source server 802, and stores the inputted application name in the source application 803. The file operation detecting module 301 stores the server name 601 received in the input in the destination server 804, stores the application name 604 received in the input in the destination application 805, stores the inputted file operation name in the file operation 806, stores the inputted pathname in the path 807, and stores the data size of the argument 809 in the argument size 808. However, in a case where the argument flag 404 in the N^{th} row of the notification management table 307 is “N”, the file operation detecting module 301 stores 0 in the argument size 808. In this embodiment, it is supposed that the unit for the argument size 808 is a byte, but even a different format will not limit the scope of the present invention. When the argument size 808 is greater than 1, the file operation detecting module 301 stores the inputted file operation argument data in the argument 809. For example, in a case where the file operation 806 is a WRITE operation, the file operation detecting module 301 stores the contents of the WRITE operation write in the argument 809. In a case where the file operation 806 is a RENAME operation, the file operation detecting module 301 stores the pre-change and post-change pathname of the filename in the argument 809.

The file operation detecting module 301 stores the attachment type 406 of the N^{th} row of the notification management table 307 in the attachment type 810. Specifically, the file operation detecting module 301 stores File, Cache (an address in the file cache memory) or ND (no data) in the attachment type 810.

In the attachment size 811, the file operation detecting module 301 stores the data size of the attachment data 812. In this embodiment, it is supposed that the unit of the attachment size 811 is a byte, but even a different format will not limit the scope of the present invention.

In the attachment data 812, the file operation detecting module 301 stores the data specified in the attachment type 810. Specifically, a file and an address in the file cache memory are stored as the attachment data 812.

(Step 912) The file operation detecting module 301 references the synchronous flag 405 in this row. If the synchronous flag 405 is “Y”, processing proceeds along “Yes”. By contrast, if the synchronous flag 405 is “N”, the processing proceeds along “No”.

(Step 913) The file operation detecting module 301 enters the created file operation data 800 at the tail end of the send queue 311. Furthermore, before entering the created file operation data 800 at the tail end of the send queue 311, the file operation detecting module 301 checks the file operation data 800 that has been entered into the send queue 311, and, with the exception of the time 801, in a case where the same file operation data 800 has been entered, may destroy the created file operation data 800 instead of entering same into the send queue 311. Reducing duplicate file operation data 800 achieves the effect of reducing the amount of communication data sent over the LAN 102 for notifying the other servers 100, reducing the amount of memory used for the send queue 311 and reducing the time and CPU load required for the destination application 221 to carry out linkage processing for the individual file operation data 800.

(Step 914) The file operation detecting module 301 ends the file operation detection sub-processing, and returns to Step 907.

(Step 915) The file operation detecting module 301 executes the file operation received as input, and returns the execution result together with the processing to the application 221.

(Step 916) The file operation detecting module 301 ends the file operation detection processing.

(Step 917) The file operation detecting module 301 sends the created file operation data 800 to the file operation notifying program 200 of the destination server 804 running the destination application 805. More specifically, using the destination server 804 of the file operation data 800 as the key, the file operation detecting module 301 searches the server name 701 column of the address management table 310, makes the management IP address 702 of the row that matches the server name 701 the destination, and sends the file operation data 800.

(Step 918) The file operation detecting module 301 checks to determine if an error occurred while executing the send process of Step 917. Specifically, an error may be a communication failure, such as failure of the destination server 804 or the failure of the network path to the destination server 804. In a case where an error has occurred, processing proceeds along “Yes”. By contrast, in a case where an error did not occur, processing proceeds along “No”.

(Step 919) The file operation detecting module 301 returns an error message to the application 221 that issued the file operation stating that an error occurred during file operation execution without executing the file operation received as input.

In the above-mentioned Steps 912, 917 to 919, the file operation detecting module 301 carried out processing that instantly returned an error message to the application 221 that issued the file operation when a file operation data 800 send error occurred. However, processing may also be such that the administrator sets a timeout time beforehand so that if a file operation data 800 send error occurs, the send operation is retried a number of times until the timeout is reached, at which point the error message is returned to the application 221 that issued the file operation.

FIG. 10 is a flowchart of a file operation receiving process by the file operation receiving module 302.

The file operation receiving process described in Steps 1000 through 1004 runs in accordance with the file operation notifying program 200 receiving a file operation data 800 send request from either the file operation detecting module 301 or the file operation sending module 305. Furthermore, the receiving process specifies the received file operation data 800.

(Step 1000) The file operation receiving module 302 starts processing by inputting the information specified by this receiving process.

(Step 1001) The file operation receiving module 302 references the destination server 804 and the destination application 805 inside the file operation data 800, and determines the virtual file server 220 and the application 221 of the destination. The file operation receiving module 302 sends the file operation data 800 to the determined application 221. A more specific explanation of the processing follows. First, the file operation receiving module 302 writes the file operation data 800 to the shared memory 240 shared by the virtual file server 220 and the file operation receiving module 302. In the meantime, the application 221 inside the virtual file server 220 regularly monitors the shared memory 240. When the application 221 detects that the file operation data 800 has been written to the shared memory 240, the application 221 checks the identifier of the destination application 805 in the file operation data 800 and fetches from the shared memory 240 only the file operation data 800 addressed to its own application 221. The application 221 that fetched the file operation data 800 carries out linkage processing with the source application 221 based on the content of the file operation data 800. For example, the linkage processing in a case where the source application 221 for the file operation data 800 is the NFS and the destination application 221 is the search engine will be described hereinafter. First, when the client 110 carries out a write to the shared file of the NFS, the file operation data 800 is notified to the search engine in accordance with the file operation notifying program 200. Next, the search engine checks to make sure the file operation 806 of the file operation data 800 is a WRITE, acquires the updated file of the path 807 of the source server 802, and carries out processing for updating the search engine index.

(Step 1002) The file operation receiving module 302 receives a return value from the application 221 that sent the file operation data 800. More specifically, the file operation receiving module 302 receives a return value by way of the shared memory 240 of the virtual file server 220 and the file operation receiving module 302.

(Step 1003) The file operation receiving module 302 returns the return value for the application 221 to the file operation notifying program 200 of the source server 802 of the file operation data 800. For instance, an example of using the return value in a case where the source application 221 is the NFS and the destination application 221 is a virus scan server will be described hereinafter. First, when the client 110 attempts to create a new file as an NFS shared file, the file operation data 800 is notified to the virus scan server by the file operation notifying program 200. Next, the virus scan server checks to make sure the file operation of the file operation data 800 is a CREATE and inspects the attachment data 812 file for viruses, returns a normal code to the source file operation notifying program 200 if it is confirmed that there are no viruses, and returns an error code to the source file operation notifying program 200 if it is confirmed that there is a virus. In a case where the source file operation notifying program 200 views the return value and finds an error code, the program 200 returns a CREATE operation error to the NFS.

(Step 1004) The file operation receiving module 302 ends the file operation receiving process, and returns processing to the file operation notifying program 200.

FIG. 11 is a flowchart of a status request process in accordance with the status request module 303.

The file operation notifying program 200 runs the status request process described in the Steps 1100 through 1105 by regularly executing the status request module 303.

(Step 1100) The status request module 303 commences processing.

(Step 1101) The status request module 303 specifies all the server management tables 309 of the file operation notifying program 200 from the group management table 308, and collects all the server names 601 registered in the respective server management tables 309. Next, the status request module 303 collects from the address management table 310 the management IP addresses corresponding to the respective server names 601.

(Step 1102) The status request module 303 sends a request for status information to all the management IP addresses collected in Step 1101.

(Step 1103) The status request module 303 receives replies to the status requests sent out in Step 1102. The received data comprises the status information of the respective virtual file servers 220.

(Step 1104) The status request module 303, based on the status information received in Step 1103, updates the CPU load 602 and I/O load 603 for the server name 601 of each row in the server management table 309.

(Step 1105) The status request module 303 ends the status request process, and returns processing to the file operation notifying program 200.

FIG. 12 is a flowchart of a status reply process in accordance with the status reply module 304.

The status reply process described in Steps 1200 through 1203 runs in accordance with the file operation notifying program 200 receiving a request for status information from the status request module 303. Furthermore, this reply process specifies the source IP address of the status request.

(Step 1200) The status reply module 304 starts processing by inputting the information specified by this reply process.

(Step 1201) The status reply module 304 collects the CPU load information or the I/O load information of the respective virtual file servers 220 inside the server 100 as status information. Furthermore, the status information collected here is merely an example, and the scope of the present invention is not limited thereto.

(Step 1202) The status reply module 304 sends the collected status information to the inputted IP address destination.

(Step 1203) The status reply module 304 ends the status reply process, and returns processing to the file operation notifying program 200.

FIG. 13 is a flowchart of a file operation sending process in accordance with the file operation sending module 305.

The file operation sending process described in Steps 1300 through 1306 runs in accordance with the file operation notifying program 200 regularly executing the file operation sending module 305. Furthermore, this file operation sending process specifies the send queue 311.

(Step 1300) The file operation sending module 305 starts the process by inputting the information specified by this file operation sending process.

(Step 1301) The file operation sending module 305 determines whether or not file operation data 800 has been entered at the head of the send queue 311. If file operation data 800 has been entered, the processing proceeds along “Yes”. By contrast, if file operation data 800 has not been entered, the processing proceeds along “No”.

(Step 1302) The file operation sending module 305 sends the file operation data 800 entered at the head of the send queue 311 to the destination application 805. More specifically, the file operation sending module 305 uses the identifier of the destination server 804 of the file operation data 800 as a key to search the server name 701 column of the address management table 310, and sends the file operation data 800 to the destination of the management IP address 702 in the row in which the destination server 804 matches with the server name 701.

(Step 1303) In a case where an error occurs during the send process, the file operation sending module 305 proceeds along “Yes”. By contrast, in a case where an error does not occur during the send process, the processing proceeds along “No”. Specifically, an error may be a communication failure resulting from a failure in the destination server 804, or a failure in the network path to the destination server 804.

(Step 1304) The file operation sending module 305 deletes the file operation data 800 at the head of the send queue 311 when the file operation data 800 was able to be sent normally, and returns to the processing of Step 1301.

(Step 1305) In a case where an error occurred while sending the file operation data 800, the file operation sending module 305 removes this file operation data 800 from the send queue 311, rotates this file operation data 800 to the tail end of the send queue 311 and returns to the processing of Step 1301.

(Step 1306) The file operation sending module 305 ends the file operation sending process, and returns processing to the file operation notifying program 200.

Furthermore, in this embodiment, it is supposed that the interval at which the file operation notifying program 200 regularly executes the file operation sending module 305 is on the order of minutes, but the scope of the present invention is not limited to the time interval. Further, a plurality of send queues 311 may be prepared in accordance with the application, and the file operation notifying program 200 may execute the file operation sending module 305 at time intervals that differ for each send queue 311 in which the file operation sending module 305 took an argument.

FIGS. 14 and 15 are examples of management windows via which the system administrator sets up the file operation notifying program 200.

FIG. 14 shows a file operation notification setting window 1400. When the system administrator executes the management program 230, the management program 230 provides the file operation notification setting window 1400.

The executed management program 230 communicates with the management module 306 of the file operation notifying program 200, acquires copies of the notification management table 307, the group management table 308 and the server management table 309 managed by the file operation notifying program 200, and stores these copies temporarily in the memory 123. The setting information of the notification management table 307, the group management table 308 and the server management table 309 temporarily stored in the memory 123 is displayed on the file operation notification setting window 1400 and the below-described group setting window 1500.

The system administrator is able to use the file operation notification setting window 1400 to carry out a file operation notification destination setting 1410 and a notification-destination group setting 1430.

The file operation notification destination setting 1410 makes it possible to add a new row, modify an existing row, or delete an existing row of the notification management table 307.

The system administrator is able to create a new row by pressing the “Add” button 1418. When the system administrator presses the “Add” button 1418, it becomes possible to input the server name 401, the application name 402, the file operation 403, the argument flag 404, the synchronous/asynchronous specification 405, the attachment type 406 and the notification-destination group name 407. The management program 230 adds the inputted information to the notification management table 307 in the memory 123.

The system administrator is also able to modify an existing row by using a radio button 1411 to specify the row and pressing the “Modify” button 1419. When the system administrator presses the “Modify” button 1419, it becomes possible to modify the server name 401, the application name 402, the file operation 403, the argument flag 404, the synchronous/asynchronous specification 405, the attachment type 406 and the notification-destination group name 407 of the row specified by the radio button 1411. The management program 230 updates the notification management table 307 in the memory 123 with the inputted information.

The system administrator is also able to delete an existing row by using a radio button 1411 to specify the row and pressing the “Delete” button 1420. When the system administrator presses the “Delete” button 1420, the management program 230 deletes the delete-targeted row from the notification management table 307 in the memory 123.

The notification-destination group setting 1430 enables the creation, revision and deletion of the group that is managed by the group management table 308 and the server management table 309.

The system administrator is able to create a new group by pressing the “Add” button 1433. When the system administrator presses the “Add” button 1433, the management program 230 displays the group setting window 1500. The group setting window 1500 will be described further below.

The system administrator is also able to modify an existing group by using a radio button 1431 to specify the group name 1432 and pressing the “Modify” button 1434. When the system administrator presses the “Modify” button 1434, the management program 230 displays the group setting window 1500. The group setting window 1500 will be described further below.

The system administrator is also able to delete an existing group by using a radio button 1431 to specify the group name 1432 and pressing the “Delete” button 1435. When the system administrator presses the “Delete” button 1435, the management program 230 searches the group name 407 column of the group management table 308 in the memory 123 for the row that matches the delete-targeted group name 407, and specifies and deletes the server management table 309 in the memory 123 from the server management table name 503 of the matching row. The management program 230 deletes the above-mentioned matching row from the group management table 308 in the memory 123.

When the system administrator presses the “OK” button 1440, the management program 230 sends the copies of the notification management table 307, the group management table 308 and the server management table 309 that have been temporarily stored in the memory 123 to the management module 306.

By contrast, when the system administrator presses the “Cancel” button 1450, the management program 230 purges the notification management table 307, the group management table 308 and the server management table 309 that have been temporarily stored in the memory 123, and closes the file operation notification setting window 1400.

FIG. 15 shows the group setting window 1500. When the system administrator presses either the “Add” button 1433 or the “Modify” button 1434, the management program 230 provides the group setting window 1500. In a case where the “Modify” button 1434 has been pressed, the management program 230 displays in the group setting window 1500 the group name 501 and the group policy 502, and the information of the server 601 and the application 604 of a target setting 1530 from the information of the group management table 308 and server management table 309 temporarily stored in the memory 123 beforehand.

The system administrator is able to use the group setting window 1500 to change the group name 501, the group policy 502 and the target settings 1530 managed by the group management table 308 and the server management table 309.

The target setting 1530 enables the addition, the revision and the deletion of the notification-destination application managed by the server management table 309.

When the system administrator presses the “Add” button 1534, the system administrator is able to register an entry constituting a pair made up of the notification-destination server 601 and the application 604. The management program 230 adds the inputted information to the server management table 309 in the memory 123.

Further, when the system administrator uses the radio button 1531 to specify the entry and presses the “Modify” button 1535, it is possible for the system administrator to modify the server name 601 and the application 604 of the entry specified by the radio button 1531. The management program 230 updates the server management table 309 in the memory 123 with the inputted information.

Further, when the system administrator uses the radio button 1531 to specify the entry and presses the “Delete” button 1536, the system administrator is able to delete this entry. The management program 230 deletes this entry from the server management table 309 in the memory 123.

When the system administrator presses the “OK” button 1540, the management program 230 stores the system administrator-inputted group name 501 and group policy 502 in the group management table 308 in the memory 123, closes the group setting window 1500, and displays the file operation notification setting window 1400. Furthermore, in a case where a group addition/deletion or a group name revision has been carried out, this information is reflected in the group setting 1430 portion of the file operation notification setting window 1400.

As long as the management program 230 is able to send the updated information of the notification management table 307, the group management table 308 and the server management table 309 to the management module 306, a window other than the ones shown in FIGS. 14 and 15 explained hereinabove may be employed. Furthermore, the management module 306, in conjunction with the above processing, replaces the notification management table 307, the group management table 308 and the server management table 309 in the memory 107 with the notification management table 307, the group management table 308 and the server management table 309 received from the management program 230.

According to the present invention described hereinabove, in a case where an application 221 of a virtual file server 220 inside a server 100 performs a file operation, a file operation notifying program 200 is able to notify the file operation to an application 221 of another virtual file server 220 inside the above-mentioned server 100 and to applications 221 of a plurality of external servers 100, making linked operation among a plurality of applications 221 possible. In this embodiment, FIG. 16 provides an example of the linkage of an NFS server and a search engine. Examples of the linkage of other applications may include the linkage of a file sharing server and a backup server, or the linkage of a file sharing server and a remote copy server. By notifying a remote copy server or a backup server that a file has been updated via a file sharing server, the file operation notifying program 200 is able to send only the updated file to the remote server via a remote copy, or store this updated file in the backup device.

Linkage with a remote copy server or a backup server makes it possible to achieve effects such as shortening update file search time, reducing backup media capacity, and reducing the amount of backup data communicated in the case of a file backup. The word “collaboration” or “cooperation” may be used instead of the word “linkage”.

What is claimed is:

1. A file server, which has a plurality of virtual file servers that are coupled to a client machine, a storage device including one or more volumes, and a management machine, the file server comprising:
a processor; and
a memory,
wherein the memory stores:
file operation notifying part executed by the processor; and
management information, which is set from the management machine, and which includes information representing correspondence relationship between respective applications on the plurality of virtual file servers, the type of file operation performed by the application, and an application that constitutes a notification destination of the file operation from among the applications on the plurality of virtual file servers,
the file operation notifying part, upon detecting a file operation from the virtual file server, specifies the application that constitutes the notification destination of the file operation from among the applications on the plurality of virtual file servers based on the application on the virtual file server that has performed the file operation, the type of file operation, and the management information, and sends file operation data corresponding to the file operation to the specified application.

2. The file server according to claim 1, wherein:
the file server is coupled to another file server having a plurality of virtual file servers, and
in a case where the file operation notifying part detects a file operation from the virtual file server and specifies an application on a virtual file server of the other file server as the notification destination of the file operation, the file operation notifying part sends the file operation data corresponding to the file operation to file operation notifying part of the other file server based on an IP address of the file operation notifying part of the other file server.

3. The file server according to Claim l,wherein:
the management information includes information as to whether or not the file operation notification to the specified application performed by the sending of the file operation data and the file operation are to be performed synchronously, and
the file operation notifying part sends an execution result of the file operation to the application that has performed the file operation, subsequent to receiving a return value from the specified application in a case where the file operation notification and the file operation are to be performed synchronously, and
the file operation notifying part sends the execution result of the file operation to the application that has performed the file operation without waiting to receive a return value from the specified application in a case where the file operation notification and the file operation are not to be performed synchronously based on the management information.

4. The file server according to claim 1, wherein:
the management information includes information representing groups each comprising a plurality of applications as information representing the applications that constitute the notification destinations of the file operation,
any one of a plurality of file operation notification policies is associated with each group, and
the file operation notifying part sends the file operation data corresponding to the file operation to the application that constitutes the notification destination of the file operation based on the file operation notification policy of the management information.

5. The file server according to claim 4, wherein any one of the plurality of file operation notification policies is either a Broadcast, which notifies the file operation to the plurality of applications inside the group, or a Round-Robin, which notifies the file operation to the plurality of applications inside the group sequentially.

6. The file server according to claim 4, wherein either a CPU load or an I/O load of a virtual file server corresponding to each of the plurality of applications inside the group is managed for each of the groups, and
any one of the plurality of file operation notification policies is either a CPU Load, which notifies the file operation to the application on the virtual file server that has the lowest CPU load of the virtual file servers corresponding to the plurality of applications inside the group, or an I/O Load, which notifies the file operation to the application on the virtual file server that has the lowest I/O load of the virtual file servers corresponding to the plurality of applications inside the group.

7. A file operation notifying method for a plurality of virtual file servers in a file server having the plurality of virtual file servers that are coupled to a client machine, a storage device having one or more volumes, and a management machine, the file operation notifying method comprising, in a case where a file operation from the virtual file server has been detected, the steps of:
referencing management information, which is stored in a memory of the file server, and which includes information representing correspondence relationship between respective applications on the plurality of virtual file servers, the type of file operation performed by the application, and an application that constitutes a notification destination of the file operation from among the applications on the plurality of virtual file servers;
specifying the application that constitutes the notification destination of the file operation from among the applications on the plurality of virtual file servers based on the management information, the application on the virtual file server that has performed the detected file operation, and the type of file operation; and
sending file operation data corresponding to the file operation to the specified application.

8. The file operation notifying method according to claim 7, wherein the file server is coupled to another file server having a plurality of virtual file servers, and
the file operation notifying method further comprises the step of, in a case where a file operation from the virtual file server is detected and an application on a virtual file server of the other file server is specified as the notification destination of the file operation, sending the file operation data corresponding to the file operation to file operation notifying part of the other file server based on an IP address of the file operation notifying part of the other file server.

9. The file operation notifying method according to claim 7, wherein the management information includes information as to whether or not the file operation notification to the specified application performed by the sending of the file operation data and the file operation are to be performed synchronously, and
the file operation notifying method further comprises the steps of:
sending an execution result of the file operation to the application that has performed the file operation, subsequent to receiving a return value from the specified application in a case where the file operation notification and the file operation are to be performed synchronously based on the management information, and
sending the execution result of the file operation to the application that has performed the file operation without waiting to receive a return value from the specified application in a case where the file operation notification and the file operation are not to be performed synchronously based on the management information.

10. The file operation notifying method according to claim 7, wherein the management information includes information representing groups each comprising a plurality of applications as information representing the applications that constitute the notification destinations of the file operation, and any one of a plurality of file operation notification policies is associated with each group, and
the file operation notifying method further comprises the step of sending the file operation data corresponding to the file operation to the application that constitutes the notification destination of the file operation based on the file operation notification policy of the management information.

11. The file operation notifying method according to claim 10, wherein any one of the plurality of file operation notification policies is either a Broadcast, which notifies the file operation to the plurality of applications inside the group, or a Round-Robin, which notifies the file operation to the plurality of applications inside the group sequentially.

12. The file operation notifying method according to claim 10, wherein either a CPU load or an I/O load of a virtual file server corresponding to each of the plurality of applications inside the group is managed for each of the groups, and
any one of the plurality of file operation notification policies is either a CPU Load, which notifies the file operation to the application on the virtual file server that has the lowest CPU load of the virtual file servers corresponding to the plurality of applications inside the group, or an I/O Load, which notifies the file operation to the application on the virtual file server that has the lowest I/O load of the virtual file servers corresponding to the plurality of applications inside the group.
